(19) United States
(12) Patent Application Publication
(10) Pub. No.: US 2023/0279555 A1
(43) Pub. Date: Sep. 7, 2023

(54) High-Pressure, Low-Temperature Coating For Hydrogen Service Environments

(71) Applicant: Halliburton Energy Services, Inc., Houston, TX (US)

(72) Inventors: Thanh Nam Vu, Singapore (SG); Arpana Singh, Singapore (SG); Michael Linley Fripp, Singapore (SG); Shashwat Shukla, Singapore (SG)

(73) Assignee: Halliburton Energy Services, Inc., Houston, TX (US)

(21) Appl. No.: 17/685,243

(22) Filed: Mar. 2, 2022

(51) Int. Cl. C23C 24/04; B33Y 80/00; B32B 15/01; C23C 4/06

(52) U.S. Cl. CPC C23C 24/04; B33Y 80/00; B32B 15/01; C23C 4/06; B33Y 10/00

(57) ABSTRACT

A coated structure may be formed with a hydrogen-resistant coating for use in a corrosive service environment. The structure may include a ferrous base metal with sufficient structural strength, despite being susceptible to hydrogen degradation in an uncoated state. A hydrogen-resistant coating is formed on the base metal without increasing a temperature of the base metal beyond a tempering temperature of the base metal. A preferred coating method is cold spraying. The cold spraying may be performed at sufficiently high pressures to achieve a low porosity without requiring a post-coating heat treatment that may otherwise reduce the strength of the base metal.

### BACKGROUND

Hydrogen induced cracking (HIC) can cause unexpected fracture of metallic components used in service environments where the components are exposed to hydrogen gases and compounds, such as in the oil and gas industry. A vast majority of metals used in such environments are susceptible to HIC. Some alloys that have been developed to resist HIC lack sufficient structural strength and/or are cost prohibitive. The study of HIC and the development of materials for use in hydrogen service environments is ongoing.

A chief concern using of metal in hydrogen storage wells is its susceptibility to hydrogen blistering, cracking, and embrittlement. There are materials that have a good hydrogen resistance, but their strength is low. If a material has a high strength, then its hydrogen resistance is normally poor. The materials that have both good hydrogen resistance and sufficient mechanical strength are generally expensive, increasing the cost of hydrogen storage wells.

### BRIEF DESCRIPTION OF THE DRAWINGS

These drawings illustrate certain aspects of some of the embodiments of the present disclosure and should not be used to limit or define the method.

FIG. 1 is a schematic representation of a representative hydrogen storage system for use in a corrosive service environment.

FIG. 2 is a schematic diagram of a cold spray system for forming a hydrogen-resistant coating on a base metal according to this disclosure.

FIG. 3 is a chart comparing the fracture resistance of different materials of different yield strengths, measured in a hydrogen service environment.

FIG. 4 is another chart illustrating the fracture resistance of low alloy steels (an optional base metal) as measured in hydrogen environment.

FIG. 5 is a schematic diagram illustrating a technical benefit of using a high-pressure cold spray to protect a base metal.

FIG. 6 is a schematic diagram of the cold spray system of FIG. 2 used for forming a hydrogen-resistant coating over a weldment.

FIG. 7 is a schematic diagram of applying multiple coating layers to the base metal.

FIG. 8 is a flowchart generally outlining an example method according to the disclosure.

### DETAILED DESCRIPTION

The present disclosure is directed in part to systems and methods to economically form a coated structural material that has a good hydrogen resistance and high strength. Various structures may be formed for use in a corrosive, hydrogen service environment, such as pressure vessels and pressure control equipment. The base metal may be coated using a low temperature method without heating the base metal above its tempering temperature. Tempering a metal generally results in changes in the microstructure, such as grain boundaries moving or changing or dislocations resolving, that reduces yield/tensile strength and hardness. The specifics of any such changes may vary depending on the material. Generally, for purposes of this disclosure, a tempering temperature is a temperature at which a post-tempering tensile strength and/or hardness of the base metal would decrease. Thus, the yield/tensile strength and hardness of a base metal at an ambient temperature prior to tempering would be greater than the tensile-strength and/or hardness of the base metal upon returning to the same ambient temperature after tempering.

A preferred coating method is cold spraying. Generally, a cold spray system and method use a heated, high-pressure carrier gas, like nitrogen or helium or air, to accelerate metal powders through a nozzle. In some cases, the nozzle may be described in the art as a supersonic nozzle, although that is not an explicit requirement herein except where otherwise may be noted. The metal particles are then bonded to a relatively high-strength base metal such as a low-alloy steel (LAS) substrate via mechanical interlocking and re-crystallization at highly strained particle interfaces. A bonding theory of cold spraying is attributed to adiabatic shear instability, which occurs at the particle substrate interface at or beyond a certain velocity called critical velocity. When a spherical particle travelling at critical velocity impacts a substrate, a strong pressure field propagates spherically into the particle and substrate from the point of contact. As a result of this pressure field, a shear load is generated which accelerates the material laterally and causes localized shear straining. The shear loading under critical conditions leads to adiabatic shear instability where thermal softening is locally dominant over work strain and strain rate hardening, which leads to a discontinuous jump in strain and temperature and breakdown of flow stresses. This adiabatic shear instability phenomena results in viscous flow of material at an outward flowing direction with temperatures close to melting temperature of the material.

In examples, a cold spray method and system are used to apply a hydrogen-resistant coating such as 316L stainless steel to a high-strength base metal such as quenched and tempered low-alloy steel, without a post-coating heat treatment. The base metal is economical and has the desired structural properties (e.g., yield strength), though it may be susceptible to hydrogen degradation in an uncoated state. The coating material may have a higher material cost on a per-unit-weight basis, but uses only a fraction of the material of the base metal. Thus, the coated material combines the low-cost and high-strength of the base metal with the hydrogen-resistance of the coating material. A thick coating may be applied that is more durable and scratch resistant than with conventional methods like electroplating.

The coating is formed on the base metal without heating the base metal above its tempering temperature, to avoid disrupting the high strength of the substrate. Unlike other coating methods like welded or thermal coating, cold spray methods do not heat the base metal above its tempering temperature. The coated material also does not require post-coating heat treatment, because the desired coating quality is instead achieved by accelerating a heated coating material to a high velocity and pressure. In examples, the application pressure may be in excess of 1.5 MPa. This high-pressure cold spray application may limit porosity to below one percent without the need for post-coating heat treatment.

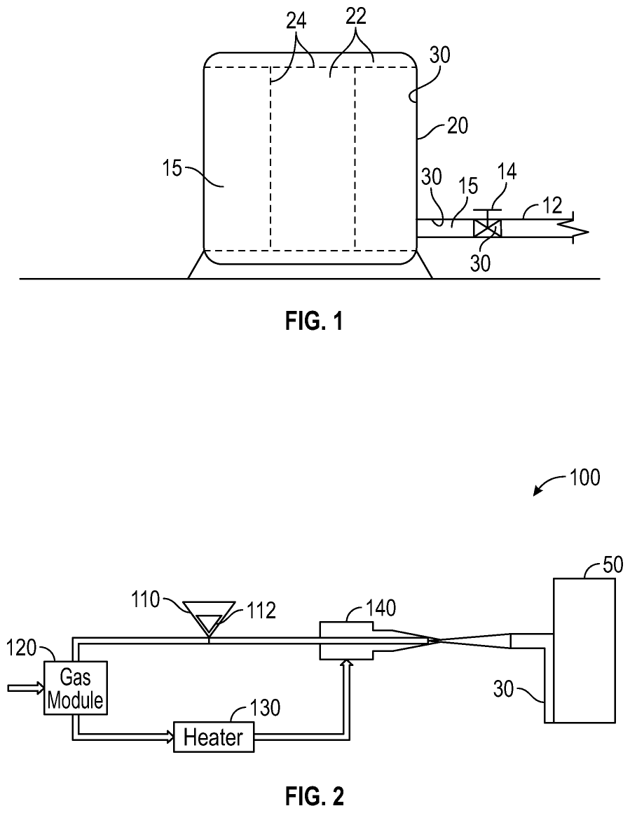

FIG. 1 is a schematic representation of a representative hydrogen storage system 10 for use in a corrosive service environment. FIG. 1 is depicted as an above-ground system but the disclosed principles may apply just as well to below-ground hydrogen storage or other equipment used in a corrosive service environment, and in particular, in a hydrogen service environment. A hydrogen service environment as used herein is a service environment with sufficient hydrogen to induce cracking or other hydrogen degradation. A hydrogen service environment may be an industrial service environment, such as a hydrocarbon recovery well in a sour-gas (i.e., H₂S) environment, a hydrocarbon refinery, or other industrial environments prone to HIC.

The hydrogen storage system 10 includes a storage tank 20 for storing hydrogen 15 in the form of a gas or other hydrogen-containing compound (the various forms of hydrogen may be generally referred to herein as hydrogen). The system 10 may include other structural elements, such as tubing 12 for conveying the hydrogen to or from the tank 20 and a valve 14 as an example of a flow control element for controlling the flow of the hydrogen 15 to or from the tank 20. These and other structural elements may comprise a ferrous base metal, such as steel, having a suitable strength for use as a structural material. For example, the base metal may have a yield strength of at least 50 kilopounds per square inch (ksi), which is approximately 345 megapascals (MPa). The strength values for different materials are widely published and can be verified by any of a variety of accepted testing practices using test specimens. In at least some structures, a higher yield strength would be desirable, such as at least 600 MPA, which may be achieved, in part, by how the base metal is processed. In some cases, for example, the yield strength of the base metal may be achieved by applying a strain-hardening treatment such as work-hardening (e.g., cold-rolling or forging) or quenching the metal in a way that achieves a desired microstructure with sufficient strength and rigidity. Then, as long as the base metal is kept below its tempering temperature while in service, the base metal and components made thereof may maintain their structural properties indefinitely throughout their useful service lives.

The base metal, despite have sufficient structural properties (e.g., yield strength), may be susceptible to hydrogen degradation in an uncoated state. For example, the system 10 may be in a generally corrosive environment in which metals, and particularly, ferrous base metals, are prone to corrosion. The presence of hydrogen in the tank 20, tubing 12, valve 14, and other structural components might otherwise hasten degradation of the base metal in its raw state. This effect may be exacerbated when the uncoated base metal is under stress in contact with hydrogen. For example, components that are under stress or strain (e.g., from stress or strain due to mechanical loading) are much more susceptible to HIC. For example, the hydrogen may make a ferrous base metal more susceptible to and/or hasten corrosive effects, including but not limited to hydrogen-induced cracking (HIC) in the uncoated state. A corrosion-resistant and hydrogen-resistant coating such as a stainless steel or other corrosion-resistant alloy may therefore be formed on the base metal to protect the base metal from hydrogen degradation. Such materials are generally more expensive and/or do not possess sufficient structural properties to be economically or structurally feasible as a base metal. For example, the material of the coatings may possess a yield strength of substantially less than the base metal. For example, the base metal may have a yield strength of at least 600 MPa and the yield strength of the coating may have a yield strength of less than 600 MPa. However, the hydrogen-resistant coating protects the base metal from hydrogen degradation, while using substantially less of that material. As further detailed below, the coating may be formed on the base metal without increasing a temperature of the base metal beyond its tempering temperature of the base metal, so as to preserve the desirable structural properties (e.g., yield strength) of the base metal.

The system 10 of FIG. 1 provides non-limiting examples of structural elements the tank 30, the tubing 12, and the valve 14—that may be formed from the base metal coated with a hydrogen-resistant coating 30. Each of these structural elements may be formed to define an interior portion for containing the hydrogen 15. The hydrogen-resistant coating 30 may be formed on at least the interior portion. For example, the storage tank 20 is a vessel defining an interior for storing the hydrogen 15 inside the tank 20. The tank 20 may be formed from multiple sheet metal sections 22. The sheet metal sections 22 may comprise the base metal for structural strength and may be work hardened. The sheet metal sections 22 may be shaped and joined at seams 24 such as by welding or brazing to form the tank 20.

The hydrogen-resistant coating 30 may be formed on at least an inside surface of the sheet metal section 22 to be exposed to the hydrogen 15, and optionally on an external surface of the tank 20. For ease of manufacturing, the hydrogen-resistant coating 30 may be formed on the base metal prior to joining the sheet metal sections 22 at the seams 24. Alternatively, it may be possible to form at least a portion of the structure (e.g., tank 20, tubing 12, or valve 14) prior to applying the hydrogen-resistant coating 30, as the hydrogen-resistant coating 30 can be applied on an outer diameter (OD) or inner diameter (ID) bigger than 1.5 inches.

The coating may be applied using techniques discussed further below (e.g., cold spraying at high pressure) without increasing a temperature of the base metal above the tempering temperature of the base metal. The coating may protect the base metal as well as any heat-affected zones where the seams 24 may be welded. The tubing, 12 the valve 14, and other structural components of the system 10 may likewise be formed of a coated base metal.

In use, the components of the hydrogen storage system 10 may be subjected to mechanical stresses of greater than the yield strength of the hydrogen-resistant coating 30 and less than the yield strength of the base metal. For example, the hydrogen 15 may be stored in the tank 20 at high pressures that impart tensile and/or shear stresses to the sheet metal sections 22 and to the seams 24. The hydrogen 15 may also be pressurized within the tubing 12 and valve 14. These stresses may exceed the yield strength of the hydrogen-resistant coating without exceeding the yield strength of the base metal. Heating the base metal above the tempering temperature could reduce the yield strength of the work-hardened portion to less than its yield strength prior to heating the base metal above the tempering temperature. However, by applying the hydrogen-resistant coating 30 without increasing the temperature of the base metal above its tempering temperature, as taught herein, the strength of the parent material used in these components will be preserved. The coating will protect the base metal so that the components of the system 10 withstand the mechanical stresses and avoid hydrogen degradation such as HIC or corrosion generally.

FIG. 2 is a schematic diagram of a cold spray system 100 for forming a hydrogen-resistant coating on a base metal 50 according to this disclosure. The base metal 50 may be any structural metal used to make equipment for a corrosive, e.g., hydrogen service environment. The cold spray system 100 in this example includes a powder feeder 110, with which the hydrogen-resistant coating material (i.e. “powder”) 112 is fed to the system 100 in particulate form. A gas module 120 directly or indirectly coupled to the powder feeder 110 houses a high-pressure carrier gas like nitrogen, helium, or air. A heater 130 is directly or indirectly coupled to the gas module 120. The powder 112 may be fed through the cold spray system 100 from the powder feeder 110, propelled by the pressurized gas through the heater 130, and accelerated through a nozzle 140. The nozzle 140 may be described in at least some embodiments as a supersonic nozzle. The heated, pressurized gas is thereby forced at high pressure out through the nozzle 140, which is used to direct the heated powder 112 at the base metal 50. The surface of the base metal acts as a substrate to receive the coating. The heated, high-velocity metal particles are bonded to the relatively high-strength base metal 50 via mechanical interlocking and re-crystallization at highly strained particle interfaces, thereby forming a hydrogen-resistant coating 30 on the base metal 50.

Desirably, unlike other coating methods, this cold spray method does not require preheat treatment or post heat treatment to the base metal 50. Although the powder 112 is heated in the process of cold-spraying, the heated powder 112 does not appreciably heat the base metal 50, so the base metal 50 may stay well below its tempering temperature, to preserve its structural strength. In principle, this cold spray approach is capable of forming the hydrogen-resistant coating 30 with a virtually unlimited thickness. In some embodiments, a preferred range of thickness is between a few microns up to 10 percent of a thickness of the base metal 50.

A variety of corrosion-resistant materials may be used for the coating to be applied by cold spray. In some embodiments, the hydrogen-resistant coating comprises one or more of a stainless steel, a nickel-based metal or metal alloy, a chrome-based metal alloy, a vanadium-based metal alloy, a gold-based metal alloy, an aluminum-based alloy, and a copper-based alloy. For stainless steels, a 316L is one preferred coating. Alternative stainless steels include, without limitation, 304, 304L, 316, 321, 347, 22-13-5, 21-6-9, A-286, and Fe—Ni—Co. Alternative nickel-based metals may include, without limitation, pure nickel, 625 alloy, or 718 alloy. Aluminum-based metals may include, without limitation, 6061 or 7075 alloys. Copper-based metals may include, without limitation, oxygen-free high conductivity copper.

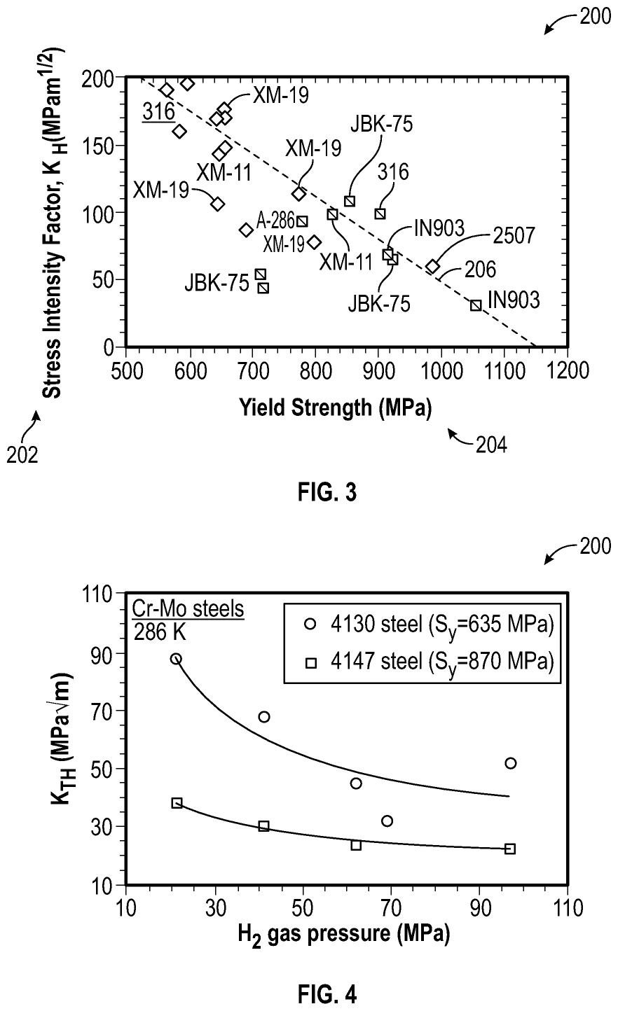

FIG. 3 is a chart comparing the fracture resistance of different materials of different yield strengths, measured in a hydrogen service environment. The vertical axis 202 represents the stress intensity factor (K_{TH}). The horizontal axis 204 represents the yield strength. K_{TH} is a measure of a material's resistance to hydrogen-assisted crack propagation under static loading. Generally, a higher K_{TH} is associated with better hydrogen resistance and a lower K_{TH} is associated with lower hydrogen resistance. A number of different materials are plotted, and a trend line 206 is drawn showing the relationship between the stress intensity factor and the yield strength. The trend line 206 indicates a trend whereby K_{TH} (hydrogen resistance) generally decreases with increasing yield strength. This helps describe why the structural materials desirable for the base metal generally have undesirable or less desirable hydrogen or corrosion resistance, whereas materials with higher hydrogen or corrosion resistance are generally less suitable alone as a structure material. For example, austenitic stainless steel 316 can be processed in different ways to vary the yield strength versus hydrogen resistance. Two examples of 316 are plotted, and the one with a yield strength less than 600 MPa showed the best fracture resistance among the tested materials. As the chart demonstrates, 316L stainless steel has desirable hydrogen resistance but a relatively low yield strength that may be unsuitable as a structural base metal in a hydrogen storage well or certain completion tools.

FIG. 4 is another chart illustrating the fracture resistance of low alloy steels (an optional base metal) as measured in hydrogen environment. Again, K_{TH} is the threshold stress intensity factor which is a measure of material's resistance to hydrogen-assisted crack propagation under static loading. The higher K_{TH} the better hydrogen resistance. As the chart shows, an uncoated low alloy steel, generally designated 41XX (e.g., 4130, 4147, etc.), has very poor hydrogen embrittlement resistance, despite a much higher yield strength, and is not recommended for the hydrogen storage well in an uncoated state. Thus, the disclosed use of cold spray techniques to form a hydrogen-resistant coating like 316L stainless steel on a strong base metal such as LAS benefits from the mechanical strength of the LAS and the excellent corrosion resistance of 316L stainless steel and the high strength of the LAS.

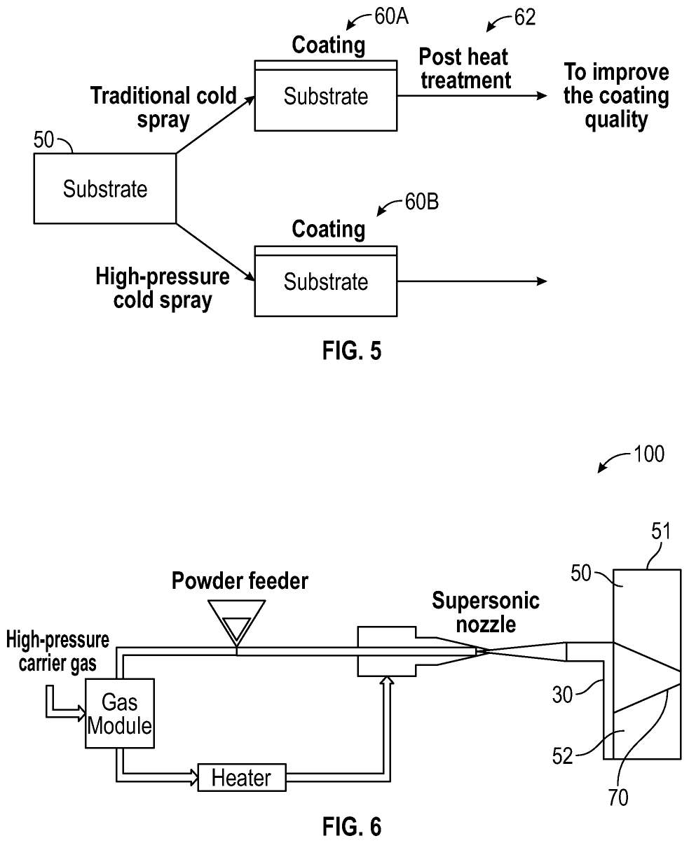

FIG. 5 is a schematic diagram illustrating a technical benefit of using a high-pressure cold spray to protect a base metal. The base metal 50 provides a suitable substrate for forming the hydrogen-resistant coating using either low pressure or high pressure. Using a low-pressure coating step indicated at 60A may require a post-heat treatment step 62 to improve the coating quality. Such post-coating heat treatments might otherwise reduce the high-strength of the base metal to below an acceptable yield strength threshold. For example, a storage tank made of the base metal with sufficient strength in a work-hardened state to withstand a hydrogen storage pressure might otherwise be reduced to a below-acceptable strength if conventional tempering or other heat treatments were performed after coating.

Instead, a high-pressure coating step indicated at 60B may achieve the same quality of coating without a post-coating heat treatment. In particular, cold-spraying at relatively high pressure helps achieve low porosity. In at least some embodiments, the cold-spraying is performed at a high pressure of at least 1.5 MPA, to achieve a porosity of less than one percent (1%). Using high pressure, low porosity is achieved without having to heat-treat the base metal, as compared with other coating methods that require post-coating heat treatments above the tempering temperature to achieve the same porosity.

FIG. 6 is a schematic diagram of the cold spray system 100 of FIG. 2 used for forming a hydrogen-resistant coating 30 over a weldment 70. The weldment 70 may be used to join two sections 51, 52 of the base metal 50. The weldment 70 may have a heat affected zone (HAZ) that is especially susceptible to hydrogen. In some examples, forming the hydrogen-resistant coating 30 on the base metal comprises selectively forming the hydrogen-resistant coating adjacent to the weldment 70, such as at the seams 24 of the storage tank 20 of FIG. 1.

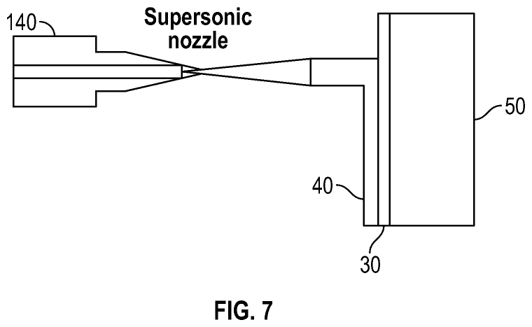

FIG. 7 is a schematic diagram of applying multiple coating layers to the base metal 50. The multiple layers may be formed by consecutively feeding different materials into the powder feeder of a cold spray system such as the system of FIG. 2. The nozzle 140 may be used to make a first pass across the base metal 50 to form a first coating layer, which may be the hydrogen resistant coating 30. Then, another material such as a high-ductility protective metal powder may be fed into the cold spray system. The nozzle 140 may be used to make a second pass across the base metal 50 to form the second coating layer 40, which may be a high-ductility protective metal coating.

Although high-pressure cold spray is the preferred method, other coating methods may alternatively be used according to this disclosure to form the hydrogen-resistant layer. For example, forming the hydrogen-resistant coating on the base metal comprises one or more of direct energy deposition (DED), wire arc additive manufacturing (WAAM), and a thermal spray method.

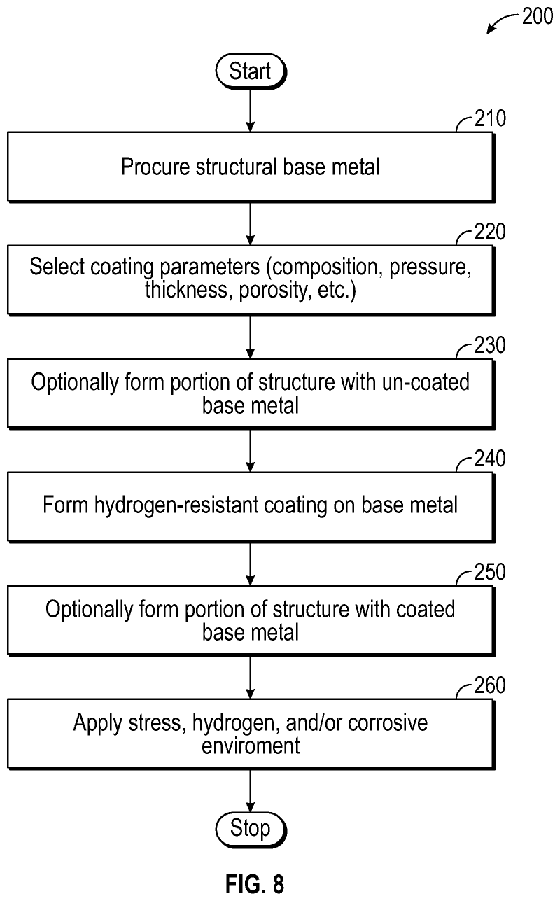

FIG. 8 is a flowchart 200 generally outlining an example method according to the foregoing principles. The flowchart 200 is generally arranged in a suggested order of steps but is not strictly limited to being performed in that order. Other methods according to this disclosure may involve steps or variations of steps substituted, added, or omitted in accordance with this disclosure. The method of the flowchart 200 may be just a portion (e.g., subroutine) of a more detailed method of forming or operating a structure in a corrosive, hydrogen service environment. The method may be automated in at least some respects.

Step 810 involves procuring a structural base metal. The structural base metal may be, for example, a low alloy steel such as 41XX steel. The base metal may have structural properties that include a yield strength of at least 345 MPa, and more preferably, in some cases, at least 600 MPa despite having a low resistance to hydrogen in an uncoated state. The base metal may be procured in a raw, uncoated form, such as a sheet metal or billet used to form structural parts.

Step 820 involves selecting coating parameters. These coating parameters may include the composition of a hydrogen-resistant coating material (e.g., 316L), the pressure at which to apply the coating material by cold spray (e.g., at least 1.5 MPA), the coating thickness to be formed (e.g., few microns to 10 percent of a thickness of the base metal), the desire porosity (e.g., less than 1 percent), and so forth. These coating parameters may be selected, for example, to achieve an expected performance level and service life based on the design parameters of the structure and the expected parameters of the hydrogen service environment.

Step 230 involves optionally forming a portion of the structure (e.g., a hydrogen service component) with uncoated base metal. For example, a component such as a pressure vessel, tubing, valve, or other flow control element may be at least partially formed from the structural base metal procured in step 210 prior to forming the hydrogen-resistant coating.

Step 240 is to form the hydrogen-resistant coating on the base metal. The coating may be formed on the base metal of a hydrogen service component that has already been formed or partially formed.

Step 250 involves optionally forming a portion of the structure with an already coated base metal. For example, in some cases the hydrogen-resistant coating may first be applied to the raw material (e.g., sheet metal) prior to forming or partially forming the component.

Step 260 involves applying a stress to the hydrogen service component or other structure while in the corrosive, hydrogen service environment. Step 260 may be performed at a design, testing, and qualifying stage, using a simulated environment, such as to ensure integrity of the component prior to being placed into service. Alternatively, step 260 may be performed with the component already in service. The stress may involve certain loading on the component, such as internal pressure applied to a hydrogen storage vessel. The resulting mechanical stresses might otherwise exacerbate hydrogen degradation if an uncoated base metal under stress were in contact with hydrogen. However, by having applied the hydrogen-resistant coating below the tempering temperature in step 240, the structure should be capable of maintaining its yield strength sufficient to withstand the applied stresses in the hydrogen service environment.

Accordingly, the disclosed systems and methods may provide a structural material for a hydrogen service environment that is coated with a hydrogen-resistant coating without exceeding a tempering temperature of the base metal. These systems and methods include but are not limited to the examples in the following statements.

Statement 1. A method, comprising: forming a structure for use in a corrosive service environment, the structure including a ferrous base metal with a yield strength of at least 345 megapascals (MPa), wherein the base metal is susceptible to hydrogen degradation in an uncoated state; and forming a hydrogen-resistant coating on the base metal without increasing a temperature of the base metal beyond a tempering temperature of the base metal.

Statement 2. The method of Statement 1, wherein the yield strength of the ferrous base metal is at least 600 MPa and the hydrogen-resistant coating has a yield strength of less than the ferrous base metal.

Statement 3. The method of any of Statements 1 or 2, wherein forming the hydrogen-resistant coating on the base metal comprises selectively forming the hydrogen-resistant coating adjacent to a weldment or forming the hydrogen-resistant coating on all of an interior portion for containing hydrogen.

Statement 4. The method of any of Statements 1 to 3, further comprising: applying a mechanical stress to the structure of greater than the yield strength of the hydrogen-resistant coating and less than the yield strength of the base metal.

Statement 5. The method of any of Statements 1 to 4, wherein the hydrogen-resistant coating is formed on a work-hardened portion of the base metal having the yield strength of at least 345 MPa, and wherein heating the base metal above the tempering temperature would reduce the yield strength of the work-hardened portion to less than 345 MPa.

Statement 6. The method of any of Statements 1 to 5, wherein forming the hydrogen-resistant coating on the base metal comprises cold-spraying a hydrogen-resistant particulate onto the base metal.

Statement 7. The method of Statement 6, wherein the cold-spraying is performed at a high pressure of at least 1.5 MPA.

Statement 8. The method of Statement 6 or 7, wherein the cold-spraying at the high pressure forms the hydrogen-resistant coating with less than 1 percent porosity.

Statement 9. The method of any of Statements 1 to 8, further comprising: forming a high-ductility layer over the hydrogen-resistant coating.

Statement 10. The method of any of Statements 1 to 9, wherein the hydrogen-resistant coating is formed with a thickness in a range of between a few microns to 10 percent of a thickness of the base metal.

Statement 11. The method of any of Statements 1 to 10, wherein the hydrogen-resistant coating comprises one or more of a stainless steel, a nickel-based metal or metal alloy, a chrome-based metal alloy, a vanadium-based metal alloy, a gold-based metal alloy, an aluminum-based alloy, and a copper-based alloy.

Statement 12. The method of any of Statements 1 to 11, wherein forming the hydrogen-resistant coating on the base metal comprises one or more of direct energy deposition (DED), wire arc additive manufacturing (WAAM), and a thermal spray method.

Statement 13. A method, comprising: forming a hydrogen-containing structure for use in a corrosive service environment, the structure including a ferrous base metal with a yield strength of at least 600 megapascals (MPa), wherein heating the base metal above the tempering temperature would reduce the yield strength of the work-hardened portion to less than 600 MPa, and wherein the base metal is susceptible to hydrogen degradation in an uncoated state; and cold-spraying a hydrogen-resistant particulate onto the base metal at a high pressure of at least 1.5 MPa to form a hydrogen-resistant coating on the base metal having a thickness of between 1 and 10 percent of a thickness of the base metal and a porosity of less than 1 percent without increasing a temperature of the base metal beyond a tempering temperature of the base metal, wherein the hydrogen-resistant coating has a yield strength of less than 600 MPA.

Statement 14. The method of Statement 13, wherein the hydrogen-resistant coating comprises one or more of a stainless steel, a nickel-based metal or metal alloy, a chrome-based metal alloy, a vanadium-based metal alloy, a gold-based metal alloy, an aluminum-based alloy, and a copper-based alloy.

Statement 15. A structure for use in a corrosive service environment, the structure comprising: a ferrous base metal with a yield strength of at least 345 megapascals (MPa), wherein the base metal is susceptible to hydrogen degradation in an uncoated state, and wherein at least a portion of the base metal is work hardened; and a hydrogen-resistant coating formed on the base metal with the work hardened portion of the base metal preserved to the yield strength of at least 345 MPa.

Statement 16. The structure of Statement 15, wherein the yield strength of the base metal is at least 600 MPa and a yield strength of the hydrogen-resistant coating is less than the yield strength of the base metal.

Statement 17. The structure of Statement 15 or 16, wherein the hydrogen-resistant coating is formed adjacent to a weldment of the base metal or on an interior portion for containing a hydrogen source.

Statement 18. The structure of any of Statements 15 to 17, wherein the hydrogen-resistant coating has a porosity of less than 1 percent and a thickness of between a few microns and 10 percent of a thickness of the base metal.

Statement 19. The structure of any of Statements 15 to 18, wherein the hydrogen-resistant coating comprises one or more of a stainless steel, a nickel-based metal or metal alloy, a chrome-based metal alloy, a vanadium-based metal alloy, a gold-based metal alloy, an aluminum-based alloy, and a copper-based alloy.

Statement 20. The structure of any of Statements 15 to 19, further comprising: a high-ductility layer formed over the hydrogen-resistant coating.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present embodiments are well adapted to attain the ends and advantages mentioned as well as those that are inherent therein. The particular embodiments disclosed above are illustrative only, as the present embodiments may be modified and practiced in different but equivalent manners apparent to those skilled in the art having the benefit of the teachings herein. Although individual embodiments are discussed, all combinations of each embodiment are contemplated and covered by the disclosure. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure.

What is claimed is:

1. A method, comprising:
forming a structure comprising a hydrogen storage system, the structure including a ferrous base metal with a yield strength of at least 345 megapascals (MPa), wherein the base metal is susceptible to hydrogen degradation in an uncoated state;
forming a hydrogen-resistant coating on the base metal comprising cold-spraying a hydrogen-resistant particulate onto the base metal without increasing a temperature of the base metal beyond a tempering temperature of the base metal; and
placing the structure with the hydrogen-resistant coating into service including storing hydrogen in the hydrogen storage system, without first performing a post-coating heat treatment.

2. The method of claim 1, wherein the yield strength of the ferrous base metal is at least 600 MPa and the hydrogen-resistant coating has a yield strength of less than the ferrous base metal.

3. The method of claim 1, wherein forming the hydrogen-resistant coating on the base metal comprises selectively forming the hydrogen-resistant coating adjacent to a weldment.

4. The method of claim 1, further comprising:
applying a mechanical stress to the structure of greater than the yield strength of the hydrogen-resistant coating and less than the yield strength of the base metal.

5. The method of claim 1, wherein the hydrogen-resistant coating is formed on a work-hardened portion of the base metal having the yield strength of at least 345 Mpa, and wherein heating the base metal above the tempering temperature would reduce the yield strength of the work-hardened portion to less than 345 Mpa.

6. (canceled)

7. The method of claim 1, wherein the cold-spraying is performed at a high pressure of at least 1.5 MPa.

8. The method of claim 1, wherein the cold-spraying at the high pressure forms the hydrogen-resistant coating with less than 1 percent porosity.

9. The method of claim 1, further comprising:
forming a high-ductility layer over the hydrogen-resistant coating.

10. The method of claim 1, wherein the hydrogen-resistant coating is formed with a thickness in a range of two microns to 10 percent of a thickness of the base metal.

11. The method of claim 1, wherein the hydrogen-resistant coating comprises one or more of a nickel-based metal alloy, a chrome-based metal alloy, a vanadium-based metal alloy, a gold-based metal alloy, an aluminum-based alloy, and a copper-based alloy.

12. A method, comprising:
forming a structure comprising a hydrogen storage system, the structure including a 41XX base metal with a yield strength of at least 345 megapascals (MPa), wherein the base metal is susceptible to hydrogen degradation in an uncoated state;
forming a hydrogen-resistant coating on the base metal without increasing a temperature of the base metal beyond a tempering temperature of the base metal; and
placing the structure with the hydrogen-resistant coating into service, including storing hydrogen in the hydrogen service system, without performing a post-coating heat treatment;
wherein the hydrogen-resistant coating comprises one or more of a nickel-based metal alloy, a chrome-based metal alloy, a vanadium-based metal alloy, and a gold-based metal alloy, wherein forming the hydrogen-resistant coating on the base metal comprises one or more of direct energy deposition (DED), wire arc additive manufacturing (WAAM), and a thermal spray method.

13-20. (canceled)

21. The method of claim 1, wherein forming the hydrogen-resistant coating on the base metal comprises selectively forming the hydrogen-resistant coating on all of an interior portion for containing hydrogen.

22. The method of claim 1, wherein the ferrous base metal has a yield strength of at least 600 megapascals (Mpa).

23. The method of claim 22, further comprising work-hardening a portion of the base metal to a yield strength of at least 600 Mpa, wherein heating the base metal above the tempering temperature would reduce the yield strength of the work-hardened portion to less than 600 Mpa.

24. The method of claim 23, further comprising forming the hydrogen-resistant coating on the base metal with a thickness of between two microns and less than 10 percent of a thickness of the base metal.

25. The method of claim 24, further comprising forming the hydrogen-resistant coating on the base metal with a porosity of less than 1 percent.

26. The method of claim 25, further comprising forming the hydrogen-resistant coating with a yield strength of less than 600 MPa.

27. The method of claim 1, further comprising:
work hardening at least a portion of the base metal prior to forming the hydrogen-resistant coating; and
forming the hydrogen-resistant coating on the base metal while preserving the yield strength of at least 345 MPa in at least the work hardened portion of the base metal.

28. The method of claim 1, further comprising forming the hydrogen-resistant coating adjacent to a weldment of the base metal or on an interior portion for containing a hydrogen source.
